(19) United States
(12) Patent Application Publication
(10) Pub. No.: US 2009/0026256 A1
(43) Pub. Date: Jan. 29, 2009

(54) Electronic Money Reader/Writer

(75) Inventor: Tomonobu Kameda, Saitama (JP)

Correspondence Address: BANNER & WITCOFF, LTD., 1100 13th STREET, N.W., SUITE 1200, WASHINGTON, DC, 20005-4051, US

(73) Assignee: SANDEN CORPORATION, Isesaki-shi (JP)

(21) Appl. No.: 11/886,581

(22) PCT Filed: Apr. 25, 2006
(86) PCT No.: PCT/JP2006/308637

§ 371 Date: Sep. 18, 2007

(30) Foreign Application Priority Data
May 10, 2005 (JP) 2005-137415

(51) Int. Cl. G07F 19/00

(52) U.S. Cl. 235/379

(57) ABSTRACT

The present invention provides an electronic money reader/writer that can perform output processing by an information outputting unit even if a settlement processing unit malfunctions, for example, and output multiple kinds of output information requiring advanced output processing based on the operation of a settlement control unit. The reader/writer comprises an output control unit 170 for controlling to output the output information 132 from an information outputting unit 140 based on respective commands received from a settlement control unit 160. This configuration allows for performing the output processing of the information outputting unit 140 only by the output control unit 170. Moreover, since not load of the settlement processing is applied to the output control unit 170, the unit 170 can output information such as a moving image or music. Therefore, even if a settlement processing unit 170 malfunctions, the information outputting unit 140 can output malfunction information and the like, and further the information such as the moving image or music is provided to a user of electronic money during the settlement processing. This improves the convenience of the settlement processing using electronic money, and encourages the user of electronic money to spend money.

### TECHNICAL FIELD

The present invention relates to an electronic money reader/writer for performing settlement processing for electronic money, and outputting information depending on the settlement processing if electronic money stored in an IC chip is used to purchase a product at a convenience store, for example.

### BACKGROUND ART

Conventionally, as such kind of electronic money reader/writer, a reader/writer is known that comprises a settlement control unit for performing settlement processing of electronic money based on the transaction amount received from a settlement terminal such as a terminal for POS (Point Of Sales) on an IC chip that stores electronic money used in an electronic money service, and a display section for displaying output information, wherein the settlement control unit is controlled to output the output information depending on the settlement processing from a display section (see Patent Document 1).

However, in the above conventional example, the settlement control unit is controlled to output the output information depending on the settlement processing from the display section. Therefore, there is a problem in that if the settlement control unit malfunctions, it cannot control the display section so that the display section cannot display anything. Moreover, if the control unit outputs letter or image information only and performs settlement using electronic money, it takes a long time to complete the settlement processing because a user of electronic money does not know at which position he/she should place an IC card, for example. Therefore, there is a problem in that the settlement processing cannot be performed smoothly.

Known information outputting units include a light emitting section for emitting pre-determined color light like a light emitting diode, or a sound outputting section for making sounds like a speaker other than a display section, for example. Using these units, a user of electronic money could understand a procedure of the settlement processing easily. In this case, the settlement control unit performs authentication between a settlement terminal and an IC chip to perform the settlement processing using electronic money in a security insured state. The authentication between the settlement terminal and the IC chip is performed using a public key cryptosystem, for example, thereby increasing the load on the settlement control unit due to the cryptographic operation. If information such as a moving image or music requiring advanced output processing is outputted, no settlement processing and moving image display load is applied to the settlement control unit so that it takes a long time for the settlement processing and the moving image display. Because of this, in order to perform the settlement processing smoothly, it is necessary to make output information outputted from a display section, a light emitting section and a sound outputting section in simple configuration to reduce the output processing load on the settlement control unit.

However, if the output information is in simple configuration, the information outputted from the display section, the light emitting section and the sound outputting section becomes monotonous. As a result, it takes a long time for a user of electronic money to understand a procedure of the settlement processing and the like. Therefore, there is a problem in that the settlement processing cannot be performed smoothly using electronic money.

### Patent Document 1: Japanese Patent Publication 2001-256567

### DISCLOSURE OF THE INVENTION

### Problems to be Solved by the Invention

In view of the above problems, it is an object of the present invention to provide an electronic money reader/writer that can perform output processing by an information outputting unit even if a settlement processing unit malfunctions, for example, and output multiple kinds of output information requiring advanced output processing based on the operation of a settlement control unit.

### Means for Solving the Problems

In order to achieve the above object, an electronic money reader/writer comprising: a settlement control unit for performing settlement processing of electronic money for an IC chip that stores electronic money used in an electronic money service based on the transaction amount received from a settlement terminal; and an information outputting unit for outputting pre-determined output information depending on the settlement processing by the settlement control unit, the present invention comprises an output control unit for controlling the information outputting unit to output the output information based on the operation of said settlement control unit.

In the electronic money reader/writer according to the present invention, the output control unit controls the information outputting unit to output the output information based on the operation of the settlement control unit, thereby allowing for the output processing of the information outputting unit only by the output control unit. Moreover, no settlement processing load is applied to the output control unit, so that it can output multiple kinds of information such as a moving image or music requiring advanced output processing.

### ADVANTAGES OF THE INVENTION

According to the present invention, the output control unit can control the information outputting unit. Therefore, even if the settlement processing unit malfunctions, for example, the output processing by the information outputting unit can be performed, and the information outputting unit can output malfunction information and the like. Moreover, the information outputting unit can output the multiple kinds of information requiring advanced output processing based on the operation of the settlement control unit, thereby improving the convenience of the settlement processing using electronic money. In addition, the provision of the information such as a moving image or music to a user of electronic money during the settlement processing can encourage the user of electronic money to spend money.

### BRIEF DESCRIPTION OF THE DRAWINGS

FIG. 1 is a functional block diagram of an electronic money reader/writer according to a first embodiment of the present invention;

FIG. 2 is a drawing showing one example of memory configuration of an IC card;

FIG. 3 is a perspective view of the electronic money reader/writer;

FIG. 4 is a drawing showing one example of data structure of a service usage history;

FIG. 5 is a drawing showing one example of data structure of output information;

FIG. 6 is a sequence diagram illustrating the operation of the electronic money reader/writer;

FIG. 7 is a sequence diagram illustrating the operation of the electronic money reader/writer;

FIG. 8 is a functional block diagram of an electronic money reader/writer according to a second embodiment of the present invention;

FIG. 9 is a sequence diagram illustrating the operation of the electronic money reader/writer; and

FIG. 10 is a functional block diagram of an electronic money reader/writer according to a third embodiment of the present invention.

### DESCRIPTION OF SYMBOLS

IC card, 100: reader/writer, 130: storage unit, 132: output information, 133: error information, 140: information outputting unit, 141: light emitting section, 142: display section, 143: sound outputting section, 150: communication device, 160: settlement control unit, 170: output control unit, 180: vibration sensor, 200: settlement device, 300: network, 400: administration server

### BEST MODE FOR CARRYING OUT THE INVENTION

### First Embodiment

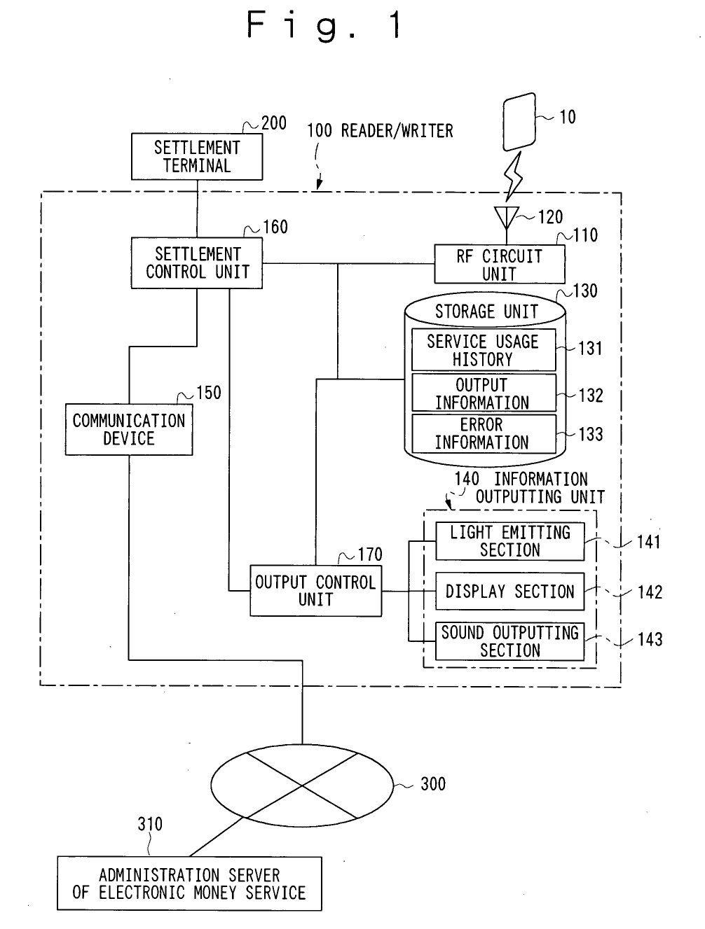

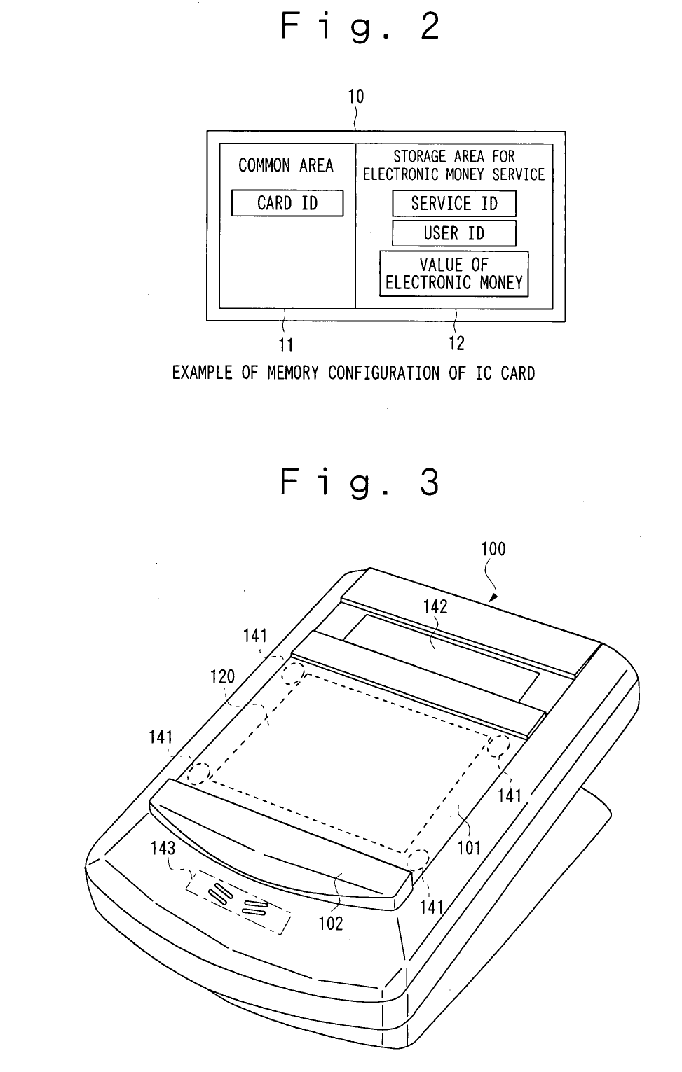

The following will describe a first embodiment of the present invention with reference to the drawings. FIG. 1 is a functional block diagram of an electronic money terminal, while FIG. 2 is a drawing illustrating memory space in an IC card.

A reader/writer 100 is an electronic money reader/writer for reading/writing such as the value of electronic money from/to an IC card 10 embedded with an IC chip for storing electronic money. The reader/writer 100 is connected to a settlement terminal 200 such as a POS terminal as shown in FIG. 1 to perform settlement processing based on the transaction amount sent from the settlement terminal 200. The reader/writer 100 can also communicate with an administration server 310 administrated by an electronic money service provider via a network 300.

The IC card 10 is embedded with a contactless IC chip that can read and write data. The memory space in the IC chip is sectioned into a plurality of storage areas, as shown in FIG. 2. In this embodiment, the space is sectioned into a common area 11 commonly available to a plurality of services using the IC card 10 and a storage area 12 for an electronic money service. The common area 11 stores a card ID specific to each card assigned to the card. The area 12 stores a service ID specific to each electronic money service assigned to the service, a user ID to identify a user in the electronic money service, and the value of electronic money (remainder of electronic money). In this embodiment, electronic money means information including at least a service ID, a user ID and the value of electronic money.

The reader/writer 100 is provided with a contact zone 101 of which center surface the IC card 10 is placed on, and provided with a locking part 102, below the zone 101, for preventing the IC card 10 slipping off, as shown in FIG. 3. The reader/writer 100 also comprises a radio-frequency (RF) circuit unit 110 for communication with the IC card 10, an antenna 120, a storage unit 130 for storing various kinds of information, an information outputting unit 140 for outputting various kinds of information, a communication device 150 such as a rooter or a modem for network connection, a settlement control unit 160 for performing the settlement processing, and an output control unit 170 for controlling the information outputting unit 140.

The RF circuit unit 110 includes an AD/DA converter, for example. The unit 110 converts a digital signal received from the settlement control unit 160 described below into an analog signal to output the result to the antenna 120. The unit 110 also converts an analog signal received from the antenna 120 into a digital signal to send the result to the settlement control unit 160.

The antenna 120 is provided on the back of the contact zone 101. The antenna 120 sends an analog radio signal outputted from the RF circuit unit 110 to the IC card 10 placed in the contact zone 101, and outputs the analog radio signal received from the IC card 10 to the RF circuit unit 110.

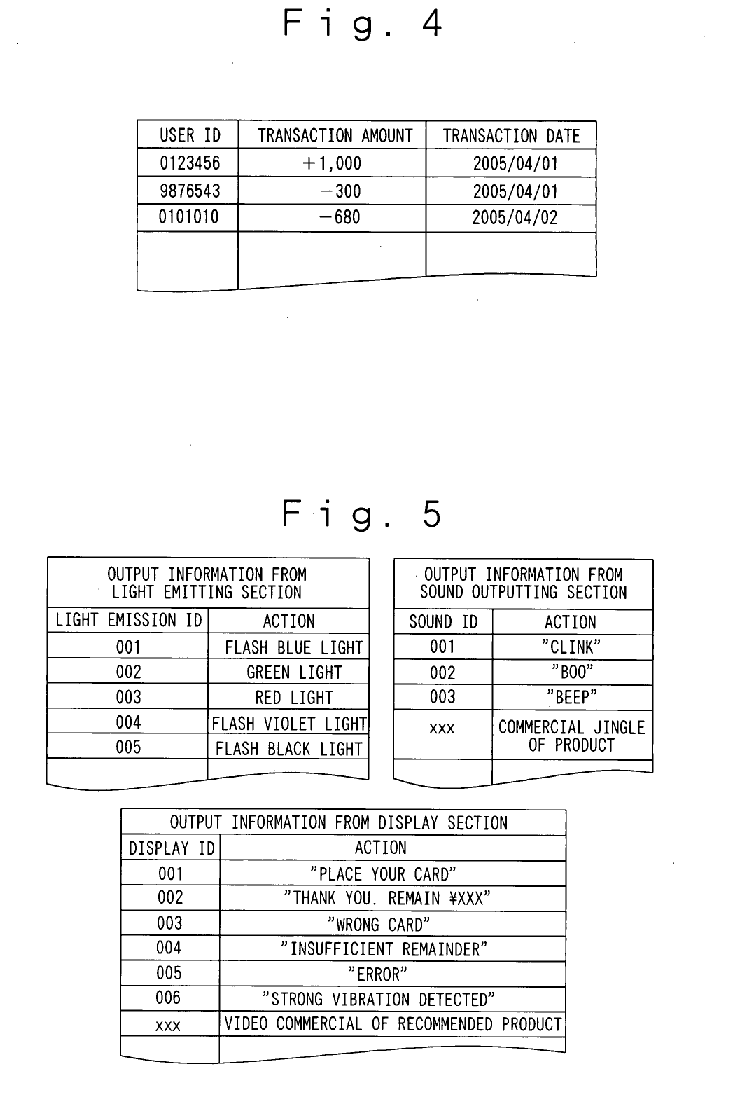

The storage unit 130 is a rewritable storage element such as an EEPROM. The unit 130 stores a user ID of a user who used an electronic money service, an electronic money usage history 131 including used amount of money, transaction date and the like, output information 132 outputted from the information outputting unit 140, and error information 133 including the time when the settlement control unit 160 malfunctions, as shown in FIG. 4. The storage unit 130 also stores a settlement processing program (not shown) to add/subtract electronic money stored in the IC chip of the IC card 10 to/from the transaction amount.

The information outputting unit 140 comprises a plurality of light emitting sections 141, a display section 142 and a sound outputting section 143. Each of the light emitting sections 141 comprises light emitting diodes (LEDs) of three colors (red, green and blue). The sections 141 are provided at the four corners on the back of the contact zone 101. Each of the light emitting sections 141 can show multiple colors of light consisting of synthesized light outputted from the LEDs through control of electric currents passed through the LEDs of respective colors by the output control unit 170 described below. Additionally, the electric currents passed through the LEDs of respective colors by the output control unit 170 are intermittent in synchronization with one another so that the light blinks that is outputted from the light emitting sections 141.

The display section 142 includes a display instrument such as a liquid crystal display (LCD) or a vacuum fluorescent display (VFD). The section 142 displays letter information stored in the storage unit 130 and the transaction amount sent from the settlement terminal 200 to the reader/writer 100 as shown in FIG. 5. The information displayed on the display section 142 can include a still image or a moving image. The sound outputting section 143 includes an instrument such as a speaker. The section 143 outputs sound information stored in the storage unit 130.

The settlement control unit 160 comprises CPU and the like. The unit 160 performs settlement processing for the IC card 10 via the RF circuit unit 110 and the antenna 120 based on the transaction amount received from a settlement device 200. The settlement processing herein is performed through execution of a settlement processing program of an electronic money service stored in the storage unit 130. Further, the settlement control unit 160 sends a control signal (a command) to the output control unit 170 depending on the status of the settlement processing. The operation of the settlement control unit 160 will be described below in detail. If the settlement processing normally ends, then the settlement control unit 160 stores the electronic money usage history 131 of the electronic money service in the storage unit 130, and sends the electronic money usage history 131 to the administration server 310 of the electronic money service via the communication device 150 at any time.

The output control unit 170 comprises CPU and the like. The unit 170 controls the light emitting sections 141, the display section 142 and the sound outputting section 143 based on a command received from the settlement control unit 160. The output control unit 170 also detects whether or not a settlement processing unit 160 malfunctions at any time. If the unit senses malfunction, it controls the light emitting sections 141, the display section 142 and the sound outputting section 143 to notify the outside about the malfunction of the settlement processing unit 160. The operation of the output control unit 170 will be described below in detail.

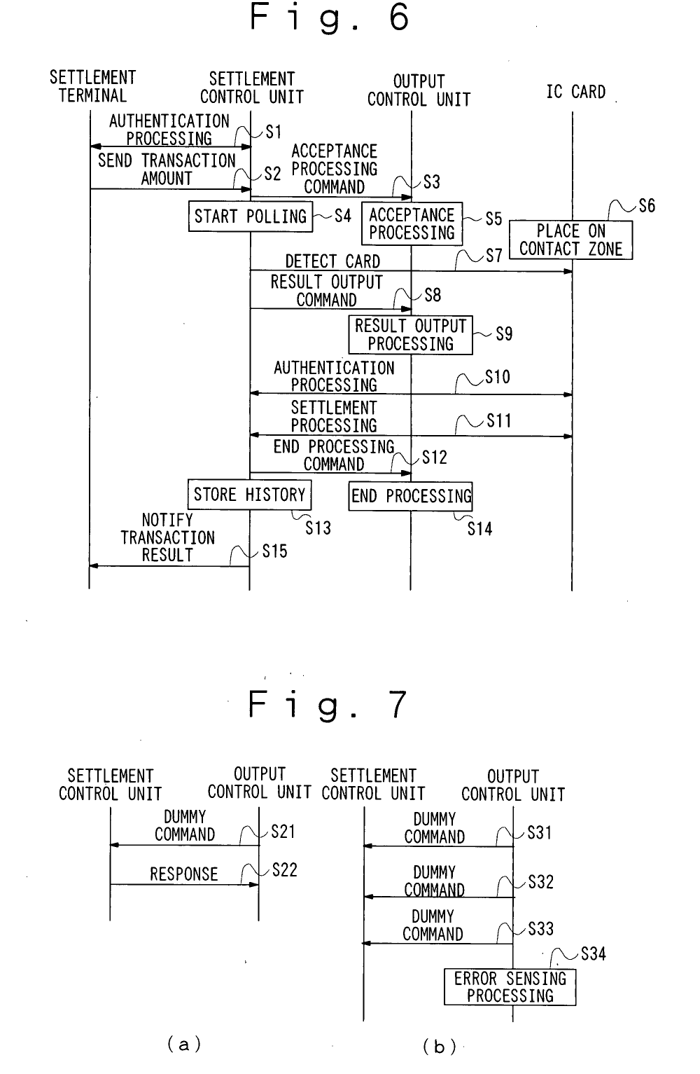

Next, the operation of the settlement processing by the reader/writer 100 will be described with reference to a sequence diagram in FIG. 6. As shown in FIG. 6, the settlement terminal 200 first performs authentication processing with the settlement control unit 160 using an authentication key (not shown) stored in the both of the terminal 200 and the unit 160 (step S1). After the authentication processing with the settlement control unit 160 normally ends, the settlement terminal 200 sends the transaction amount to the settlement control unit 160 (step S2).

The settlement control unit 160 sends the transaction amount received from the settlement terminal 200 as well as an acceptance processing command to the output control unit 170 (step S3), starts polling processing to sense whether or not the IC card 10 is detected, and releases an analog radio signal from the antenna 120 (step S4). The output control unit 17Q extracts information to be outputted from the information outputting unit 140 from the output information 132 stored in the storage unit 130 based on the acceptance processing command, and then outputs the extracted information from the information outputting unit 140 (step S5). For example, of the output information 132 shown in FIG. 5, an action of a light emission ID 001 is outputted from the light emitting sections 141 and an action of a display ID 001 and the transaction amount are outputted from the display section 142.

Then, when a user of electronic money places the IC card 10 in the contact zone 101 (step S6), the settlement control unit 160 detects electronic money stored in the IC card 10 (step S7). At this time, the settlement control unit 160 detects electronic money by determining whether or not a service ID of a service stored in the IC card 10 is same as a service ID of a settlement processing program stored in the storage unit 130. Then, the settlement control unit 160 sends a result output command to the output control unit 170 (step S8). For example, if the settlement control unit 160 does not detect electronic money from the IC card 10 at the step S7, it can stop the settlement processing after sending the result output command containing a parameter (for example “1”) indicating that it has not detected electronic money to the output control unit 170. If the settlement control unit 160 detects electronic money from the IC card 10, it can perform processing at step S10 described below without performing the processing at step S8.

Next, the output control unit 170 outputs the output information 132 from the information outputting unit 140 based on the parameter contained in the received result output command (step S9). For example, if the parameter contained in the result output command is “1”, the output control unit 170 outputs an action of light emission ID 003 from the light emitting sections 141, an action of display ID 003 from the display section 142, and an action of sound ID 002 from the sound outputting section 143.

Then, the settlement control unit 160 performs authentication processing with the IC card 10 (step S10), and then performs settlement processing (step S11). Particularly, the unit 160 reads out a user ID from electronic money stored in the IC card 10 via the RF circuit unit 110 and the antenna 120, and adds or subtracts the transaction amount to or from the value of electronic money. Then, the settlement control unit 160 sends an end processing command to the output control unit 170 in order to output the result of the settlement processing from the output control unit 170 (step S12). For example, if the settlement processing normally ends, the settlement control unit 160 sends the end processing command containing a parameter (for example “0”) indicating the normal end to the output control unit 170. If the settlement processing abnormally ends due to such as a shortage of value of electronic money in the IC card 10, the unit 160 sends the end processing command containing a parameter (for example “1”) indicating the abnormal end to the output control unit 170. Next, a settlement control unit 170 stores the user ID read out from the IC card 10 and used amount of money in the service usage history 131 (step S13).

Then, the output control unit 170 performs the end processing based on the end processing command received from the settlement control unit 160 (step S14). Particularly, if the parameter contained in the received end processing command is “0”, the output control unit 170 outputs an action of light emission ID 002 from the light emitting sections 141, an action of display ID 002 from the display section 142, and an action of sound ID 001 from the sound outputting section 143. If parameter is “1”, the unit 170 outputs the action of light emission ID 003 from the light emitting sections 141, an action of display ID 004 from the display section 142, and the action of sound ID 002 from the sound outputting section 143. Finally, the settlement control unit 160 sends the transaction result to the settlement terminal 200 (step S15).

Next, the operation when the output control unit 170 senses malfunction of the settlement control unit 160 will be described with reference to a sequence diagram in FIG. 7. As shown in FIG. 7, the output control unit 170 senses malfunction by sending a dummy command to the settlement control unit 160 periodically (for example, every minute). For example, as shown in FIG. 7 (a), when the settlement control unit 160 receives a dummy command from the output control unit 170 (step S21) while the settlement control unit 160 is functioning normally, it responds to the output control unit 170 (step S22). The content of the response can be the same as a dummy command, or a message of one-byte length. If the operation of the settlement control unit 160 stops due to malfunction or the like, the settlement control unit 160 does not respond even if the output control unit 170 sends a dummy command to the settlement control unit 160 for multiple times at pre-determined intervals (for example, every five seconds) as shown in FIG. 7 (b) (steps S31 to S33). During the processing, the output control unit 170 senses that the settlement control unit 160 malfunctions, and outputs the output information 132 indicating that the information outputting unit 140 malfunctions (step S34). For example, the output control unit 170 outputs an action of light emission ID 004 from the light emitting sections 141, an action of display ID 005 from the display section 142, and an action of sound ID 003 from the sound outputting section 143. Then, the output control unit 170 records the time when it has sensed the malfunction in the error information 133 of the storage unit 130.

As described in the above, the reader/writer 100 according to this embodiment comprises the output control unit 170 for controlling the information outputting unit 140 to output the output information 132 based on the respective commands received from the settlement control unit 160, so that the reader/writer 100 can perform the output processing only by the information outputting unit 140 using the output control unit 170. The output control unit 170 can output information such as a moving image or music since no load of the settlement processing is applied to the unit 170. Therefore, even if a settlement processing unit 170 malfunctions, the information outputting unit 140 can output malfunction information and the like. Further, the provision of information such as a moving image or music during the settlement processing to a user of electronic money improves the convenience of settlement processing using electronic money and encourages the user of electronic money to spend money.

The storage unit 130 for storing the multiple kinds of output information 132 is comprised, so that the output control unit 170 can further output the output information 132 stored in the storage unit 130. Therefore, the present invention can encourage users of electronic money to spend money by continuing to output campaign information or product commercial information while the settlement processing is not performed.

The output control unit 170 is further configured to output the output information 132 indicating malfunction from the light emitting sections 141, the display section 142 and the sound outputting section 143 of the information outputting unit 140 if it is sensed that the settlement control unit 160 has not responded to a dummy command sent out for multiple times. This makes it possible to confirm malfunction of the settlement control unit 160 using light, letters (or an image), or a sound. This can give notice of malfunction early, thereby shortening a time to find a malfunctioning part.

The information outputting unit 140 comprises the light emitting sections 141 that can emit light of multiple colors, while the output control unit 170 is configured to control the color of light outputted from the light emitting sections 141 based on the respective commands received from the settlement control unit 160. This also makes it possible to alter the color of light outputted from the light emitting sections 141 depending on the result of the settlement processing. This can show the result of the settlement processing certainly and quickly in a visual way.

The information outputting unit 140 comprises the display section 142 for displaying letters or an image, while the output control unit 170 is configured to control information outputted from the display section 142 based on the respective commands received from the settlement control unit 160. This also makes it possible to alter letters or an image outputted from the display section 142 depending on the result of the settlement processing. This can give notice of the result of the settlement processing or the remainder of electronic money stored in the IC card 10 certainly. It can also encourage users of electronic money to spend money by providing information of such as a product or a service.

The information outputting unit 140 is provided with the sound outputting section 143 for outputting sound information, while the output control unit 170 is configured to control the sound information outputted from the sound outputting section 143 based on the respective commands received from the settlement control unit 160. This also makes it possible to alter a sound outputted from the sound outputting section 143 depending on the result of the settlement processing. This can give the result of the settlement processing certainly and quickly in an auditory way.

### Second Embodiment

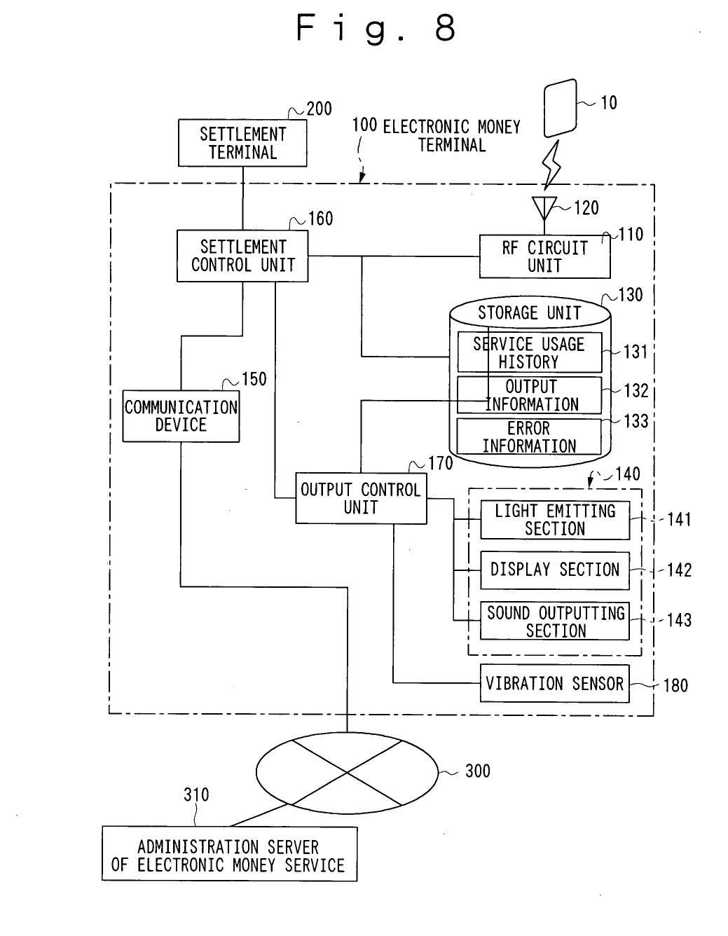

An electronic money reader/writer according to a second embodiment of the present invention will be described. This embodiment differs from the first embodiment in that the reader/writer comprises a vibration sensor 180 for sensing vibration and the vibration sensor 180 is connected to the output control unit 170, as shown in FIG. 8. This configuration allows for the reader/writer 100 to sense applied vibration. Other configuration and operation are similar to those of the first embodiment, so that only the differences will be described herein.

The vibration sensor 180, which is a well known sensor, is comprised within the reader/writer 100. The vibration sensor 180 detects the acceleration or displacement of vibration caused in the reader/writer 100 from impact or the like from the outside, converts the magnitude of the detected vibration into an electric current and outputs the result to the output control unit 170.

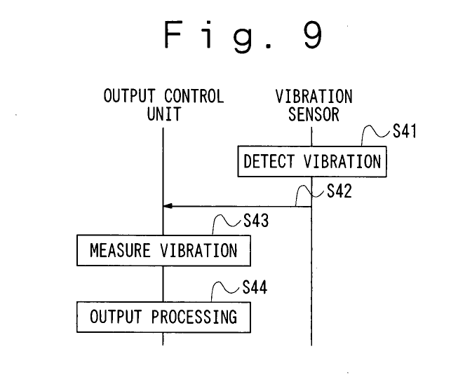

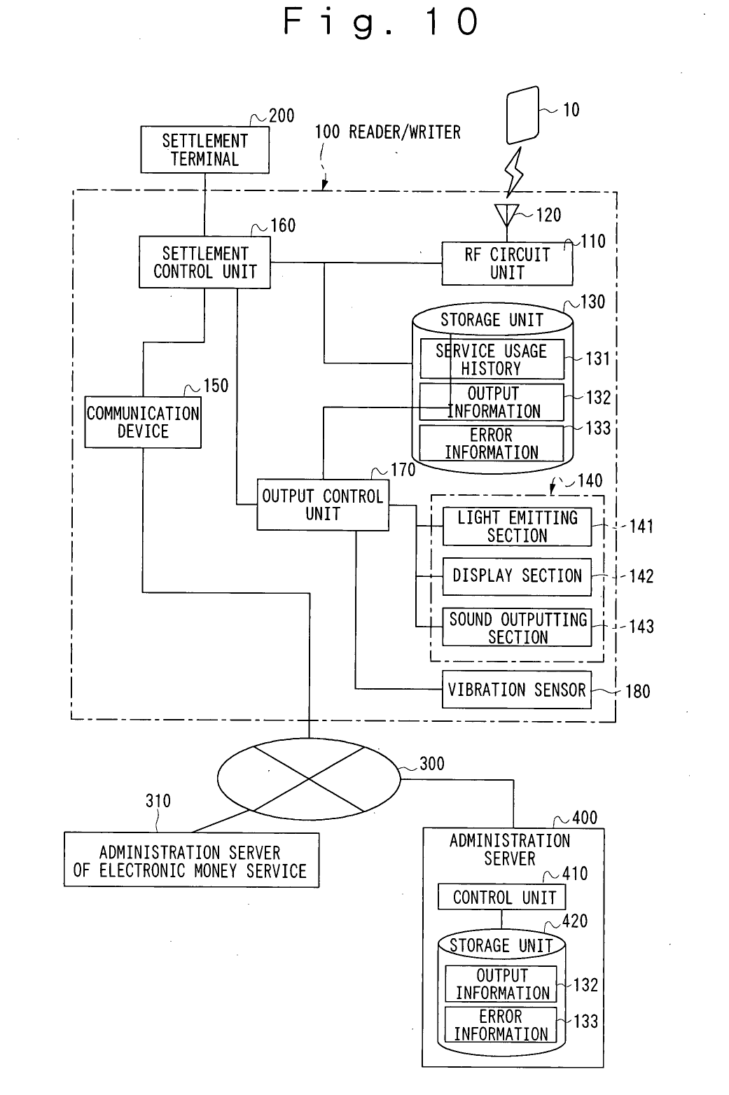

The operation of the reader/writer 100 according to this embodiment when vibration occurs in the reader/writer 100 will be described with reference to a sequence diagram in FIG. 9. The vibration sensor 180 always detects vibration caused in the reader/writer 100 after the reader/writer 100 starts up (step S41). Then, the vibration sensor 180 converts the magnitude of the detected vibration into an electric current and outputs the result to the output control unit 170 (step S42). The output control unit 170 converts the electric current passed from the vibration sensor 180 into the vibration value based on an output property of the vibration sensor 180 to measure the vibration value (step S43). Next, if the measured vibration value is a predetermined threshold or more, then the output control unit 170 recognizes abnormality, and outputs the output information 132 indicating that the abnormal vibration is applied to the reader/writer 100 from the information outputting unit 140 (step S44). For example, the unit 170 outputs an action of light emission ID 005 from the light emitting sections 141, an action of display ID 006 from the display section 142, and the action of sound ID 003 from the sound outputting section 143 of the output information 132 shown in FIG. 5. The output control unit 170 can send a signal indicating that the abnormal vibration is detected to the settlement control unit 160 and the settlement terminal 200 after the processing at the step S44.

As described in the above, the electronic money reader/writer according to this embodiment comprises the vibration sensor 180 for sensing vibration, while the output control unit 170 is configured to output the output information 132 representing that the abnormal vibration is applied from the information outputting unit 140 if the vibration value sensed by the vibration sensor 180 is a predetermined threshold or more. This makes it possible to sense vibration caused in the reader/writer 100. Therefore, the reader/writer 100 can be readily arranged in the environment where no vibration is caused, i.e. the environment where no output information based on the magnitude of vibration is outputted, thereby preventing the reader/writer 100 from malfunctioning due to vibration.

### Third Embodiment

An electronic money reader/writer according to a third embodiment of the present invention will be described. This embodiment differs from the first and second embodiments in that the reader/writer sends and receives the output information 132 and the error information 133 to and from an administration server 400 connected to the network 300. Other configuration and operation are similar to those of the first and second embodiments, so that only the differences will be described herein.

The administration server 400 comprises a control unit 410, a storage unit 420 and the like as shown in FIG. 10, and can communicate with the reader/writer 100 via the network 300. The storage unit 420 stores the output information 132 and the error information 133. When the control unit 410 receives a request to send the output information 132 stored in the storage unit 420 from the reader/writer 100, it authenticates that the reader/writer 100 is a right terminal using such as a public key cryptosystem, and then sends the output information 132 stored in the storage unit 420 to the reader/writer 100. The control unit 410 also stores the error information 133 received from the reader/writer 100 at any time in the storage unit 420. An administrator of the administration server 400 can refer to the output information 132 and the error information 133 stored in the storage unit 420 using a monitor or a keyboard (both not shown) comprised in the administration server 400, and updates the output information 132 such as campaign information or a commercial of a product or a service.

The output control unit 170 according to this embodiment is connected to the communication device 150, and can communicate with the administration server 400 via the network 300. The output control unit 170 connects to the administration server 400 at any time to detect the output information 132 not stored in the storage unit 130 of the reader/writer 100 of the output information 132 stored in the storage unit 420 and send a request to send the detected output information 132 to the administration server 400. An output control unit 160 sends the error information 133 stored in the storage unit 130 to the administration server 400 at any time.

As described in the above, the electronic money reader/writer according to this embodiment comprises the communication device 150 for network connection, while the output control unit 170 is configured to send the error information 133 to the administration server 400 via the communication device 150. So the error information 133 is sent from the communication device 150 to the administration server 400 via the network 300. Therefore, if a plurality of reader/writers 100 are used, operation statuses of the respective reader/writers 100 can be seen collectively.

The reader/writer further comprises the communication device 150 for network connection, while the output control unit 170 is configured to receive the output information 132 from the administration server 400 and store the output information 132 in the storage unit 130 via the communication device 150. This makes it possible to store the output information 132 received from the administration server 400 in the storage unit 130. Therefore, if a plurality of reader/writers 100 are used, the same output information 132 can be set for the respective reader/writers 100 easily.

Although an IC card embedded with an IC chip for contactless communication has been described with respect to the above embodiments, the IC chip can be loaded into a mobile phone, a wrist watch or a PDA, for example.

1. An electronic money reader/writer comprising:
a settlement control unit for performing settlement processing of electronic money for an IC chip that stores electronic money used in an electronic money service based on the transaction amount received from a settlement terminal;
an information outputting unit for outputting pre-determined output information depending on the settlement processing by the settlement control unit; and
an output control unit for controlling the information outputting unit to output the output information based on the operation of said settlement control unit.

2. The electronic money reader/writer according to claim 1, comprising:
a storage unit for storing multiple kinds of output information.

3. The electronic money reader/writer according to claim 1,
said output control unit is configured to output the pre-determined output information from the information outputting unit if the output control unit senses that the settlement control unit does not function normally.

4. The electronic money reader/writer according to claim 3, comprising:
a communication device for network connection,
wherein said output control unit is configured to send the pre-determined output information to a pre-determined administration server via the communication device.

5. The electronic money reader/writer according to claim 1,
said information outputting unit comprises a light emitting section that can emit light of multiple colors; and
said output control unit is configured to control the color of light outputted from the light emitting section based on the operation of the settlement control unit.

6. The electronic money reader/writer according to claim 1,
said information outputting unit comprises a display section for displaying information that is visible from the outside; and
said output control unit is configured to output pre-determined information from the display section based on the operation of the settlement control unit.

7. The electronic money reader/writer according to claim 1,
said information outputting unit comprises a sound outputting section for outputting sound information; and
said output control unit is configured to output pre-determined sound information from the sound outputting section based on the operation of the settlement control unit.

8. The electronic money reader/writer according to claim 1, comprising:
a vibration sensor for sensing vibration,
wherein said output control unit is configured to output the pre-determined output information from the information outputting unit if the vibration sensor senses vibration of a pre-determined magnitude or more.

9. The electronic money reader/writer according to claim 1,
comprising:
a communication device for network connection,
wherein said output control unit is configured to receive multiple kinds of output information from a pre-determined administration server via the communication device, and output the output information from the information outputting unit.
